(19) United States
(12) Patent Application Publication
(10) Pub. No.: US 2026/0245569 A1
(43) Pub. Date: Aug. 20, 2026

(54) SYSTEMS AND METHODS FOR LOW BANDWIDTH TRANSMISSION STRATEGY FOR HUMAN-COMPUTER-CLOUD AUDIO INTERACTIONS

(71) Applicant: Agora Lab, Inc., Santa Clara, CA (US)

(72) Inventors: Jimeng Zheng, Shanghai (CN); Bo Wu, Shanghai (CN); Haoran Xu, Shanghai (CN); Zhen Zhang, Shanghai (CN)

(21) Appl. No.: 19/059,064

(22) Filed: Feb. 20, 2025

(51) Int. Cl. G10L 19/04

(52) U.S. Cl. CPC G10L 19/04

(57) ABSTRACT

Systems and methods for low bandwidth transmission strategies for human-computer-cloud audio interactions are provided. The methods and systems includes receiving an input signal which is then converted into a digital signal. When the downstream device is the intended target of the input, and it will be applying computational models to the input, the front-end device may receive feedback from the downstream device on the capabilities of the downstream device, and the requirements of the computational models. The front-end device may query the requirements information and the downstream device capabilities to determine exactly what information is needed from the digital signal, and generate tokens of smaller pieces of data responsive to the requirements and the device capabilities. These tokens may be transmitted to the downstream device for operation on by the computational models.

### BACKGROUND

The present invention relates in general to the field of audio processing and transmission, and more specifically to methods, computer programs and systems for low bandwidth transmission strategies for human-computer-cloud audio interactions. This invention relates to the field of artificial intelligence algorithms utilized in streaming voice interaction systems. The invention specifically relates to network transmission that includes the optimization of uplink data content through intelligent strategies when a voice interaction is performed between a human-machine terminal and a cloud terminal.

In traditional voice transmission, the original audio pulse code modulation (PCM) data is transmitted through the network to a downstream application/processor. In large scale human-computer voice interaction scenarios, this kind of full-link transmission of the original PCM data may lead to significant increase in the network bandwidth load.

Sometimes the downstream resources require the entire PCM data in its original form. This may be especially true for human-to-human interactions where the audio needs to be reproduced with near perfect fidelity. In other use cases, however, there may not be a need for the full original PCM data to be transmitted. In these situations, the transmission of the original PCM data may be overly conservative, and reproduces information that is redundant or not required for the end use application.

Network bandwidth may be a significant bottleneck in many voice interaction applications, especially where there is a very large number of concurrent interactions to a single endpoint. For example, a smart speaker scenario where many thousands of smart speakers are being serviced by a single data center may result in a bottleneck of network bandwidth at the server end.

Given that there is great value in maintaining low bandwidth network transmissions for large scale human-computer voice interactions, systems and methods for low bandwidth transmission strategies for human-computer-cloud audio interactions is provided.

### SUMMARY

The present systems and methods relate to audio processing, and particularly to low bandwidth transmission strategies for human-computer-cloud audio interactions. Such systems and methods allow for more instances of human voice communications over a cloud backbone than would be possible if all human-computer interactions were to be transmitted in their entirety.

In some embodiments, the methods and systems for low bandwidth transmission strategies for human-computer-cloud audio interactions includes receiving an input signal. In many cases the input signal is an audio signal, but in some embodiments the input signal may be a video signal or other signal type. The input signal is then converted into a digital signal. In the case of an audio input, the conversion of the signal may be from the analog signal to a pulse code modulation (PCM) data stream.

Next the system determines the purpose of the downstream device. Particularly, a determination is made if the downstream device is facilitating a human-to-human interaction or a human-to-computer interaction. When the downstream device is outputting to another human, the front end device may transmit the original PCM data to the downstream device. The downstream device may then decode the encoded PCM data and play back the audio to the recipient.

Conversely, if the downstream device is the intended target of the input, and it will be applying computational models to the input, the front-end device may receive feedback from the downstream device on the capabilities of the downstream device, and the requirements of the computational models. Often the computational models do not require the original PCM data, but rather only a subset of the data. The front-end device may query the requirements information and the downstream device capabilities to determine exactly what information is needed from the digital signal, and generate tokens of smaller pieces of data responsive to the requirements and the device capabilities.

These tokens may be transmitted to the downstream device for operation on by the computational models. These models may include large language models (LLMs) or other artificial intelligence (AI) models. The results of the models may include the generation of an audio or other data stream. This audio stream may be decoded into an output audio. Alternatively, the downstream device may provide data back to the front-end device or to another third party device.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example illustration of a traditional human-computer voice interaction with original audio pulse code modulation data transmission, in accordance with some embodiment;

FIG. 2 is an example illustration of an intelligent system for tokenizing human-computer voice interactions prior to transmission when available for reduced network bandwidth requirements, in accordance with some embodiment;

FIG. 3 is a flow diagram for an example process of low bandwidth transmission strategies for human-computer-cloud voice interactions, in accordance with some embodiments;

FIG. 4 is a flow diagram for an example sub-process of full data transmission, in accordance with some embodiments; and

FIGS. 5A and 5B are illustrations of computer systems capable of implementing processing of human-computer voice interactions, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for low bandwidth strategies for human-computer-cloud voice interactions. As noted previously, large scale human-computer interactions may generate significant network bandwidth concerns, especially when the endpoint processing of these interactions is centrally located. For example, in a very large number of front-end systems, such as smart speakers, smart phones, and other internet of things (IOT) devices are capable of receiving human voice commands, and all these instances of voice data are being processed at a single endpoint (for example a server farm), the network restrictions at the endpoint may become problematic. One way to address this is to increase the available bandwidth. However, increasing bandwidth is often impractical or prohibitively expensive. The other solution to this issue is to reduce bandwidth requirements by either servicing fewer devices, or through the reduction in the bandwidth needed for any given device. Obviously, servicing fewer devices is problematic, thus, the best solution is to reduce the overall bandwidth requirements per device. The following disclosure focuses on systems and methods to help realize this reduced bandwidth strategy.

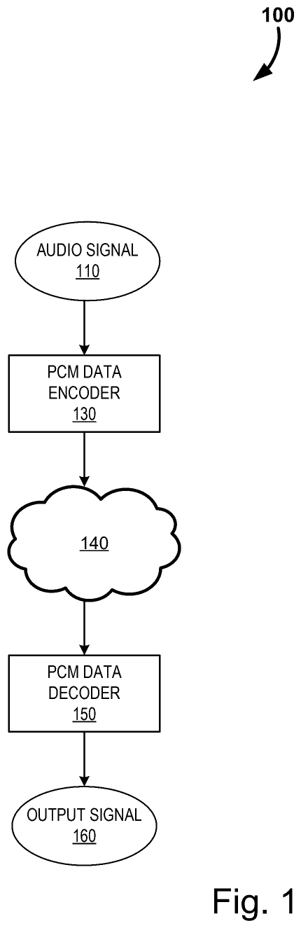

To facilitate discussions, FIG. 1 provides an example illustration of a traditional system, as employed today, that allows for human-to-computer voice interactions with complete transmission of the resulting audio, shown generally at 100. Generally, the audio signal 110 is received by a device capable of recording and transmitting the audio signal. This device may be extremely “light weight” with relatively limited computational resources. For example, the device may include a smart speaker, smart doorbell, other IOT device, etc. In alternate embodiments, the device may include more significant computational resources, such as a computer terminal, smart phone, or the like. In some embodiments, the device may include a speaker that plays sounds, in which case the device may be deigned to receive a far end reference signal which is used in various audio processing techniques to reduce echoes resulting from the played audio. A recorder collects the main audio signal 110 and converts it into an electrical signal. Typically, the recorder includes one or more microphones. In some cases, adaptive microphone selection techniques may be employed to select the optimal microphone for usage from among a plurality of microphone devices.

Typically, the device then undergoes a series of audio compensation techniques (not illustrated). In some cases, the audio compensation includes at least acoustic echo cancellation (AEC), adaptive noise suppression (ANS) and automatic gain controller (AGC). The front end recording may be provided to an AEC module for noise cancellation along with the far-end reference signal (if present). The AEC module subtracts out the time-delayed far end reference signal from the near end audio signal 110 to remove echo artifacts. The adjusted signal is then provided to a module that analyzes the ambient noise. This ANS module adjusts the signal further to remove ambient noise from the signal. The further adjusted signal is provided to an AGC which is a circuit that is a closed-loop feedback regulating circuit that adjusts the relative amplification of the signal to ensure a consistent volume level. This results in a clean, consistent audio signal.

The audio signal is then provided to an encoder that converts the pulse code modulation (PCM) data into an encoded format for transmission. Pulse-code modulation (PCM) is a method used to digitally represent analog signals. It is the standard form of digital audio in computers and other digital audio applications. In a PCM stream, the amplitude of the analog signal is sampled at uniform intervals, and each sample is quantized to the nearest value within a range of digital steps.

The encoded PCM data is transmitted across a network 140 for downstream analysis. The transmission may be via local Wi-Fi, cellular, via the internet, or by some combination of the above. This transmission via the cloud 140 results in the signal being routed to a decoder 150 located in an end/downlink device for decoding the received signal. The downlink device may include a computer, server farm, smartphone, or other computationally rich device capable of performing the audio playback and/or other processing on the audio signal. In this example illustration the original PCM data is received by the decoder 150, decoded, and the output signal 160 may include the playback of the signal to another human.

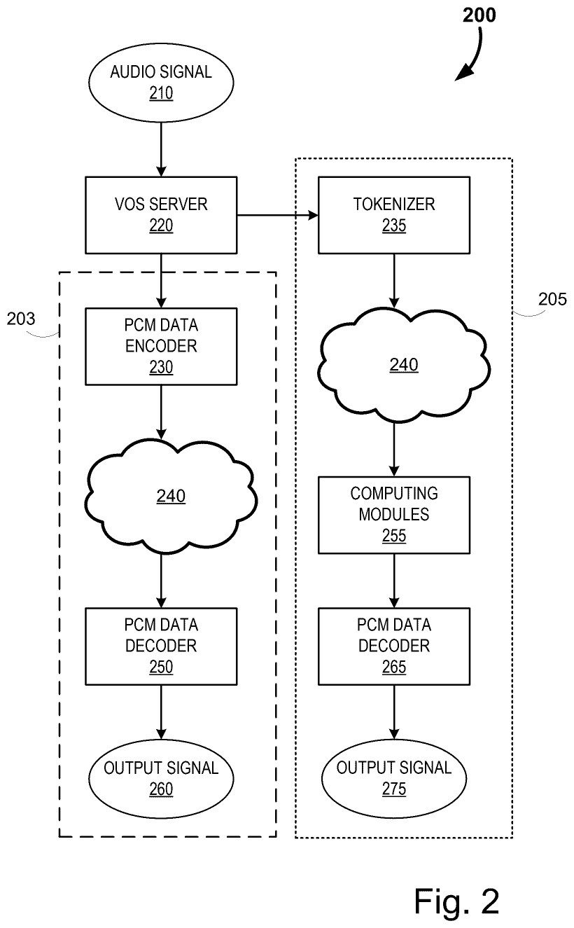

Now that the method of audio transmission has been described as performed by existing systems, examples shall be provided of the improved system that results in a reduction of the required bandwidth. FIG. 2 provides an example of this intelligent system, shown generally at 200, which includes a dual pathway of transmission of audio signals. Much like the traditional system, there needs to be a device that the human is interacting with. This device may include any computerized device capable of receiving an audio signal 210 and transforming them into digital signals. A voice (VoS) server 220 may initially receive the digitized signal and may receive feedback from the downstream device what the downstream device's capabilities are, and the end usage of the audio data. For example, the audio sample may be utilized for human-to-human interaction, such as a digital call. This use case mandates the entire audio signal be transmitted to the end device and will involve one of the pathways 203. In contrast, the end purpose of the voice signal may be a human-computer interaction, which requires different segments or types of data to be transmitted. This use case may implicate the other transmission pathway 205.

If the downstream device requires the original PCM data set, as noted above as being the case where the interaction is between humans, such as a digital call, then the system may progress in much the same manner as described in FIG. 1 above. The VoS server 220 may direct the digital signal to undergo signal processing before transmission. This may include the audio compensation techniques previously discussed (AEC, ANS and AGC). The PCM data encoder 230 may take the original PCM data and encode it for transmission. Transmission may be over a network 240, as previously discussed. The network generally includes the internet, but may also consist of wireless networks, cellular networks and the like. The encoded signal is ten received at the downstream device, where it is decoded by the decoder 250 which yields the original PCM data. This data may be converted back into an analog output signal 260 that may be played by a speaker for a human audience.

If however, the end use of the voice signal is for human-to-computer interactions, then the second pathway 205 may be leveraged instead. In this pathway, the audio signal is also subjected to initial signal compensation techniques for the removal of echoes, ambient noise and for gain control (not illustrated). However after this initial compensation processing, rather than encoding the entire PCM signal, the system may cause the PCM signal to undergo a tokenization step by a tokenizer 235. The tokenizer 235 is a processing element that is in communication with the downstream device and receives feedback from the downstream device on the types of data required by the downstream computing modules 255 in order to operate effectively. Often the downstream computing modules 255 include specific artificial intelligence (AI) algorithms, each algorithm with specific input requirements. This may include requiring only specific segments of the audio signal, or specific elements of the audio signal. For example, in some cases, only audio signals containing command triggers need to be provided to the downstream computing modules 255. In other embodiments, only audio signals of a specific amplitude or frequency need be provided. In yet other embodiments, non-speech and other information-less segments of the audio signal may be omitted from the transmitted signal. The tokenizer 235 may encode these tokens/unit streams for transmission. Again, the tokens/unit streams are task related pieces of information and are inherently less information than the original PCM data. These smaller encoded pieces of data are then transmitted via the network 240, and a utilized by the downstream computing modules 255. These downstream computing modules 255 may include elements such as large language models (LLMs) and other AI computing models, such a speech recognition models, and the like. The results of these models may include the generation of PCM data (either entirely new PCM data or PCM data using the tokens), which is then provided to a decoder 265 to generation of an output signal 275. This process, by leveraging tokens for transmission as opposed to the full set of original PCM data, results in reduced bandwidth requirements.

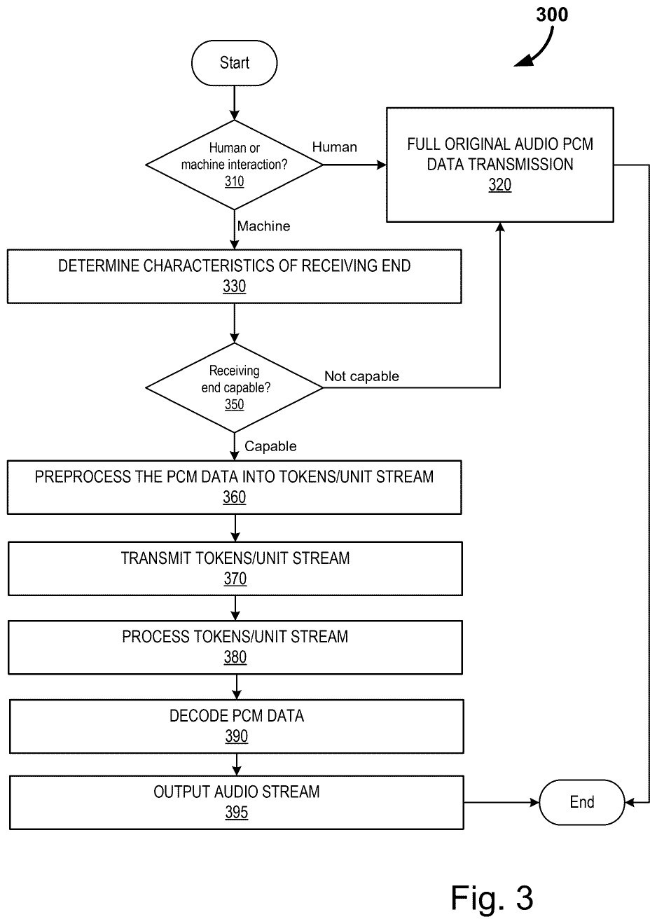

FIG. 3 provides a more in-depth discussion and explanation of the system's operation, as seen generally at 300. Initially, the process starts with the VoS server determining, based upon feedback from the downstream system, the nature of the audio interaction (at 310). Human-to-human interactions are treated differently from human-to-computer interactions. If the interaction is with a human on the downstream end, a full original audio PCM data transmission sub-process may be preformed (at 320). Conversely, if the interaction is a human-to-computer interaction, then an additional step is performed for determining the characteristics of the receiving end (at 330). The processing capability at the receiving end must be sufficient for receiving encoded tokens, and the task requirements must be for input data consisting of less than the entire PCM data stream in order for the system to undergo tokenization. As such, the system decides based upon downstream system capability and task requirements. If the system is capable (at 350) of tokenizing the PCM data, then this reduced bandwidth process may be employed. However, if the requirements or capabilities demand that the original full PCM data be transferred, the full original audio PCM data transmission sub process may be employed (at 320).

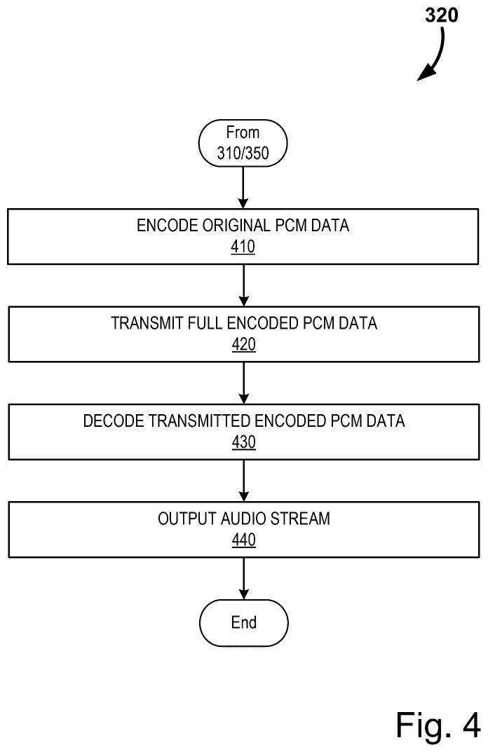

Turning briefly to FIG. 4, the sub process for the transmission of the full PCM data is provided. In this example sub-process, the PCM data is first subjected to any data pre-processing that may be required. This may include, at a minimum, automatic gain control, but may also include echo noise cancellation, when a far-end signal is available, and other acoustic noise suppression techniques. These pre-processing steps are not illustrated.

Next, the original PCM data set may be encoded by an encoder (at 410). Encoding may include the usage of one or more audio codecs for compressing the audio signal for transmission. The full encoded PCM data signal may then be transmitted (at 420) over a network to the downstream device. At the downstream device, the received signal is decoded (at 430) to generate a exact, or near exact output of the original audio signal (at 440). This audio signal may be played back to another human user, or may be supplied to a machine for additional audio processing.

Returning to FIG. 3, if the system is capable of sending a token as opposed to the full PCM data stream (at 350), then the system may preprocess the PCM data into tokens or unit streams (at 360). These tokens are task specific, and correspond to specific downstream requirements by computational models. Tokens are smaller than the original PCM data set, and as such result in a significant reduction in bandwidth when transmitted as compared to the original PCM data set.

The system transmits the tokens/unit stream after they are generated (at 370) to the downstream system. The downstream system includes computational modules that may ingest the tokens and perform computations on the tokens. Computations include processing by LLMs or other AI models (at 380). The output of the processing may include the generation of a new PCM data file. This may include generated PCM data or may be populated with pieces of data located within the tokens. The PCM data may be decoded (at 390) and the audio stream may be output (at 395). Audio output may be optional in some circumstances, as the interaction may be entirely between the human and the machine. Rather than generate an output audio at the downstream device, for example, data may be returned to the front-end device, in some embodiments. This could, for example, include an audio file to be played back to the human interacting with the front-end device. Alternatively, data may be supplied to one or more additional devices, such as smart phones and the like. For example, a human may interact with a smart doorbell which collects the audio from the human user. The audio is tokenized for only the information of interest, which is then transmitted to a backend server device. This server may perform LLM analysis, in this example, and return a message to the doorbell, and provide an interaction synopsis to the owner of the home's cellphone, in this particular example. The foregoing example is merely for illustrative purposes. The use cases for the described low bandwidth transmission methods and systems are intentionally left broad to any human-computer audio interaction.

Furthermore, while audio interactions are the focus of this present disclosure, the described systems and methods may be extended to video and other data of interest. For example, a video may be collected at the front-end device, and only portions of the video of interest to the backend device computational models may be transmitted as unit segments or portions of the video signal. This may further enable even lower bandwidth transmissions for audio and video systems.

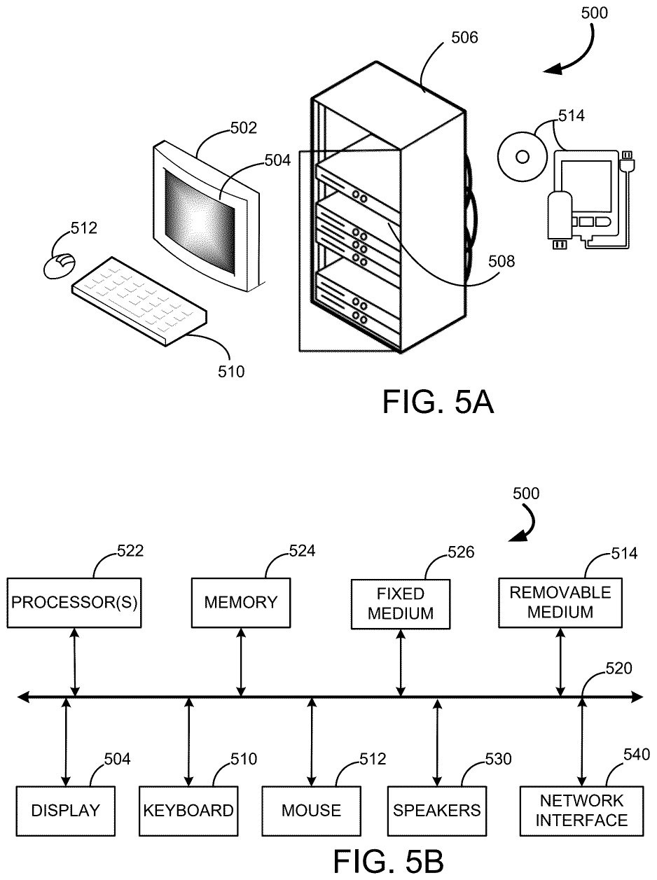

Now that the systems and methods for low-bandwidth transmission strategies for human-computer-cloud voice interactions have been provided, attention shall now be focused upon apparatuses capable of executing the above functions in real-time. To facilitate this discussion, FIGS. 5A and 5B illustrate a Computer System 500, which is suitable for implementing embodiments of the present invention. FIG. 5A shows one possible physical form of the Computer System 500. Of course, the Computer System 500 may have many physical forms ranging from a printed circuit board, an integrated circuit, and a small handheld device up to a huge supercomputer. Computer system 500 may include a Monitor 502, a Display 504, a Housing 506, server blades including one or more storage Drives 508, a Keyboard 510, and a Mouse 512. Medium 514 is a computer-readable medium used to transfer data to and from Computer System 500. FIG. 5B is an example of a block diagram for Computer System 500. Attached to System Bus 520 are a wide variety of subsystems. Processor(s) 522 (also referred to as central processing units, or CPUs) are coupled to storage devices, including Memory 524. Memory 524 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 526 may also be coupled bi-directionally to the Processor 522; it provides additional data storage capacity and may also include any of the computer-readable media described below. Fixed Medium 526 may be used to store programs, data, and the like and is typically a secondary storage medium (such as a hard disk) that is slower than primary storage. It will be appreciated that the information retained within Fixed Medium 526 may, in appropriate cases, be incorporated in standard fashion as virtual memory in Memory 524. Removable Medium 514 may take the form of any of the computer-readable media described below.

Processor 522 is also coupled to a variety of input/output devices, such as Display 504, Keyboard 510, Mouse 512 and Speakers 530. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 522 optionally may be coupled to another computer or telecommunications network using Network Interface 540. With such a Network Interface 540, it is contemplated that the Processor 522 might receive information from the network, or might output information to the network in the course of performing the above-described low-bandwidth transmission methods. Furthermore, method embodiments of the present invention may execute solely upon Processor 522 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 500 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for low bandwidth transmission of human-computer interactions, the method comprising:
receiving an input signal;
converting the input signal into a digital signal;
converting the digital signal into at least one token, wherein the aggregate of the at least one token is smaller than the digital signal;
transmitting the at least one token to a downstream device; and
performing at least one computational model on the at least one token.

2. The method of claim 1, wherein the input signal is an audio signal.

3. The method of claim 2, wherein the digital signal is an original pulse code modulation (PCM) data stream.

4. The method of claim 1, wherein the token is generated responsive to the capabilities of the downstream device and the requirements of the at least one computational model.

5. The method of claim 1, further comprising determining if the downstream device includes the at least one computational model or a human interface.

6. The method of claim 5, further comprising when the downstream device includes the human interface transmitting the entire digital signal.

7. The method of claim 1, wherein the at least one computational model includes at least one of a large language model (LLM) and an artificial intelligence (AI) model.

8. The method of claim 1, wherein the input signal includes a video signal.

9. The method of claim 1, wherein the at least one token is encoded for transmission.

10. The method of claim 1, further comprising generating an output signal at the downstream device and outputting the output signal.

11. A computerized system for low bandwidth transmission of human-computer interactions, the system comprising:
a front-end device configured to receive an input signal, convert the input signal into a digital signal, and convert the digital signal into at least one token, wherein the aggregate of the at least one token is smaller than the digital signal;
a network for transmitting the at least one token to a downstream device; and
the downstream device configured to perform at least one computational model on the at least one token.

12. The method of claim 1, wherein the input signal is an audio signal.

13. The method of claim 2, wherein the digital signal is an original pulse code modulation (PCM) data stream.

14. The method of claim 1, wherein the token is generated responsive to the capabilities of the downstream device and the requirements of the at least one computational model.

15. The method of claim 1, wherein a voice server on the front-end device is configured to determine if the downstream device includes the at least one computational model or a human interface.

16. The method of claim 5, wherein the front-end device transmits the entire digital signal when the downstream device includes the human interface.

17. The method of claim 1, wherein the at least one computational model includes at least one of a large language model (LLM) and an artificial intelligence (AI) model.

18. The method of claim 1, wherein the input signal includes a video signal.

19. The method of claim 1, wherein the at least one token is encoded for transmission.

20. The method of claim 1, wherein the downstream device is further configured to generate an output signal and output the output signal.
